(19) United States
(12) Patent Application Publication
(10) Pub. No.: US 2018/0192176 A1
(43) Pub. Date: Jul. 5, 2018

(54) INTEGRATED ACOUSTIC RECEIVER AND ANTENNA APPARATUS AND METHOD OF OPERATION

(71) Applicant: Sound Solutions International Co., Ltd., Beijing (CN)

(72) Inventor: Karan J. Jumani, Schaumburg, IL (US)

(21) Appl. No.: 15/736,676

(22) PCT Filed: Jun. 17, 2016
(86) PCT No.: PCT/CN2016/086126

§ 371 Date: Dec. 14, 2017

Related U.S. Application Data
(60) Provisional application No. 62/180,883, filed on Jun. 17, 2015.

(51) Int. Cl. H04R 1/06; H04R 9/06; H04R 9/02

(52) U.S. Cl. CPC H04R 1/06; H04R 2499/11; H04R 9/025; H04R 9/06

(57) ABSTRACT

A combination speaker and antenna device is provided wherein one or more metal components of a speaker apparatus is connected to an antenna circuit on a printed circuit board to operate as an antenna in a mobile device. Additional elements can be added to the combination device to extend the antenna and/or electrical circuitry can be added to dynamically select different additional elements.

### TECHNICAL FIELD

This application relates to receivers or speakers and, more specifically, using these devices as antennas.

### BACKGROUND OF THE INVENTION

An antenna is a transducer that converts electrical signals on a device to radiated electromagnetic waves and vice-versa. The dimensions, geometry, surrounding materials and the method of connections of the antenna dictate the frequency range(s) (band(s)) in which the antenna works well (i.e. where the antenna resonates).

Speakers and receivers are also used in today's electronic devices. Generally speaking, a speaker receives an electrical signal and converts the electrical signal into sound energy for presentation to the listener.

Speakers and receivers are often used in proximity to antennas in the same electronic device. For example, in cellular phones there is a speaker or receiver that presents sound to the ear of a listener. There are also antennas by which the cellular phone makes transmissions from the cellular phone to a cellular and/or other networks and vice versa (e.g., Bluetooth or WIFi networks). Personal computers, laptops, wearable device, and tablets also may have both speakers and antennas.

Speakers and receivers have traditionally been viewed as a hindrance to antenna performance. To mitigate the effect on antenna performance, speakers/receivers have been kept at a distance from antennas.

However, previous approaches have not proved entirely satisfactory because of both performance and space concerns. The problems of previous approaches have resulted in some user dissatisfaction with these previous approaches.

### BRIEF DESCRIPTION OF THE DRAWINGS

For a more complete understanding of the disclosure, reference should be made to the following detailed description and accompanying drawings wherein:

FIG. 1 comprises a side cutaway view of an apparatus including a speaker that is used as an antenna according to various embodiments of the present invention;

FIG. 2 comprises a simplified bottom view of the pot of the speaker of FIG. 1 according to various embodiments of the present invention;

FIG. 3 comprises a simplified side cutaway view of part of the speaker of FIG. 1 and FIG. 2 according to various embodiments of the present invention;

FIG. 4 comprises a bottom perspective view of the speaker portion of the apparatus of FIGS. 1, 2, and 3 according to various embodiments of the present invention;

FIG. 5 comprises a bottom view of an apparatus with a speaker that has an extended antenna according to various embodiments of the present invention;

FIG. 6 comprises a side cutaway view of the apparatus of FIG. 3 according to various embodiments of the present invention;

FIG. 7 comprises a side view of an extended antenna including a switch according to various embodiments of the present invention;

FIG. 8 comprises a side view of an apparatus that includes a dielectric according to various embodiments of the present invention;

FIG. 9 comprises a view of a PCB with electrical circuits according to various embodiments of the present invention;

FIG. 10 comprises a view of a PCB with switchable electrical circuits according to various embodiments of the present invention;

FIG. 11 comprises a perspective view of a speaker disposed in an integrated assembly according to various embodiments of the present invention;

FIG. 12 comprises a block diagram showing the speaker used with choking components according to various embodiments of the present invention.

Skilled artisans will appreciate that elements in the figures are illustrated for simplicity and clarity. It will further be appreciated that certain actions and/or steps may be described or depicted in a particular order of occurrence while those skilled in the art will understand that such specificity with respect to sequence is not actually required. It will also be understood that the terms and expressions used herein have the ordinary meaning as is accorded to such terms and expressions with respect to their corresponding respective areas of inquiry and study except where specific meanings have otherwise been set forth herein.

### DETAILED DESCRIPTION

The present approaches provide for using part(s) speakers/receivers as the antenna element. The speaker/receiver may either form a part of a larger antenna or the entire antenna element itself. It may be used either in part or wholly as any type of antenna including but not limited to Inverted F antennas (IFA), Planar Inverted F antennas (PIFA), patch antennas, inverted L antennas (ILA), and monopole antennas. Other examples of antennas are possible.

Receivers are typically small (around 10-13 mm long) and their short lengths are used in the approaches described herein to resonate at higher RF frequencies utilized for antennas. Receiver dimensions can be electrically elongated/shortened by several approaches to help them resonate at any RF frequency range desired such as those used in mobile phone communications (e.g., Bluetooth, WI-Fi, 3G, 2G, GSM, CDMA, LTE, and so forth).

There are various approaches and combinations of approaches that can achieve these goals. It will be appreciated that many of the approaches described herein can be combined with others of these approaches.

In many of these examples, the metallic body (including magnets) of the speaker (receiver) may be used to be (part of) the antenna. As used herein, the terms “speaker” and “receiver” are used interchangeably. More specifically, the receiver (or portions of the receiver such as the pot or yoke) forms part of the antenna element. Additional elements can be added to the speaker to extend the antenna so-created. These additional elements can be constructed using other metallic structures (including but not limited to Laser Direct Structuring (LDS) traces, conductive ink/tape/adhesives, flexible PCBs, fixed PCB traces, stamped metal piece etc. or some combination of the above). A switch may be used to dynamically select different additional elements. Other examples are possible.

In other aspects, the size/shape of receiver can be changed to make the receiver resonate at various different frequencies.

In other examples, electrical circuits (involving the use of inductors, capacitors, resistors, impedance matching circuits, and combinations of these elements to mention a few examples) either on the receiver or connected to the antenna (e.g., on a PCB) created by using the speaker (or portions of the speaker) as an antenna.

In still other aspects, switches (including but not limited to electronic, electrical, mechanical, MEMs switches), variable antenna matching circuits or some combination of these may also be used to tune the resonant characteristics of the receiver to help it resonate across or within bands of interest or desired frequency ranges.

In other examples, the receiver may be encased in an integrated assembly such as an Integrated Speaker Assembly (or Box) or an Integrated Receiver Assembly (or Box) where many of the above techniques can be implemented.

In yet other aspects, the receiver may be disposed in proximity to a dielectric material (including but not limited to different plastics and ceramics). This deployment is effective to alter the frequencies at which the receiver antenna can radiate.

In still other examples, the spatial location where the RF signal is fed onto the speaker/receiver and where a connection to ground or antenna counterpoise is located are changed to change or adjust the frequency of operation.

In other aspects, the speaker pot may be used as an antenna element over the PCB where it resonates like a Planar Inverted-F or Patch antenna. The frequency of resonance can be adjusted using the techniques described above.

When necessary, the choking components (including but not limited to inductors, common mode chokes, ferrite beads, and capacitors to mention a few examples) may be placed between the speaker's audio ports and audio device's circuitry to block higher frequency RF currents from flowing across them. These choking components may also be included in the receiver/speaker or in a speaker box as well.

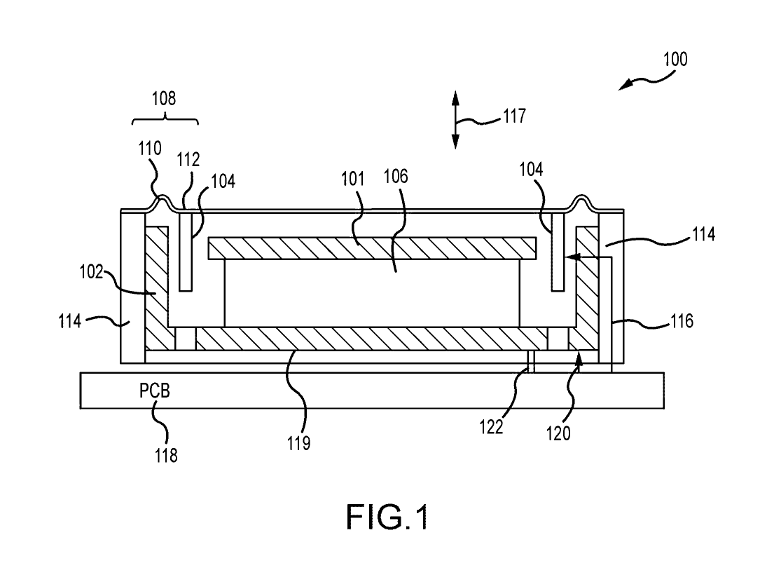

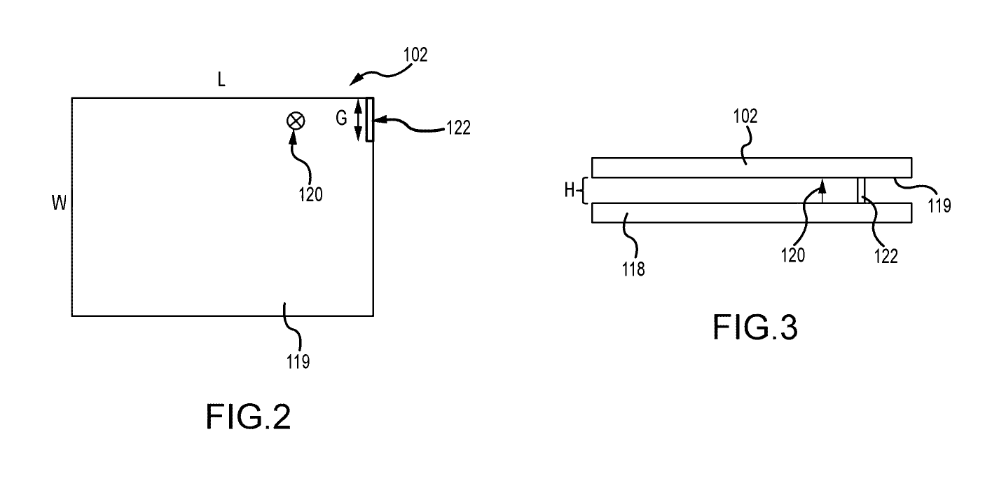

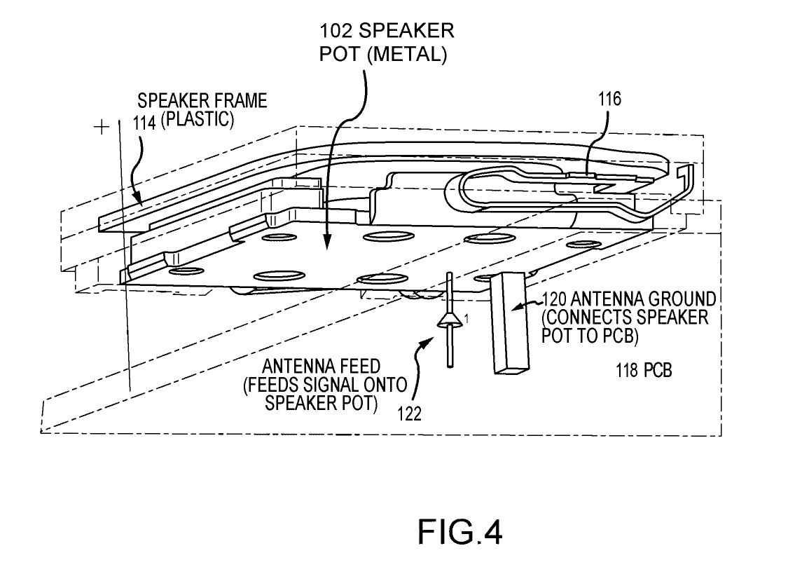

Referring now to FIG. 1, FIG. 2, FIG. 3, and FIG. 4 one example of a receiver (or speaker) apparatus includes a top plate 101, a pot 102, a coil 104, magnets 106, a membrane 108 (including a torous 110 and dome 112) and a basket 114. Leads 116 supply an audio signal into the coil. In the presence of the magnetic field, the coil moves. The coil 104 is attached to the membrane 108 and consequently movement of the coil 104 moves the membrane 108 up and down in the direction of the arrow labeled 117. Movement of the membrane 108 creates sound, which can be presented to a user. The basket 114 may be disposed or situated on a printed circuit board (PCB) 118. Leads 116 may originate from the printed circuit board 118.

An antenna feed 120 and antenna ground 122 originate from the printed circuit board 118. The antenna feed 120 and antenna ground 122 provide an RF signal that is fed to the speaker 100.

Parts of the speaker apparatus 100 act as an antenna. In one aspect, the pot 102 acts as an antenna. The pot 102 may be constructed of a suitable metal such as steel. Other examples are possible.

The pot has a surface 119 that is generally rectangular in shape. The bottom surface has a length (L) and a width (W). A small gap of distance (H) separates the PCB 118 and surface 119 (for clarity). The antenna ground pin has a width (G). The relative dielectric of the material between the speaker pot and the PCB is EPSILON_R. This material may include but is not limited to air, plastic, ceramics and combinations of them. The size and geometry of the bottom portion of the pot speaker (length, width) and the antenna ground lead (G) or portions thereof are adjustable and configured. It will be appreciated that the antenna feed may touch anywhere on the pot (e.g., side surface or bottom surface).

A wave length (LAMBDA) is where the wavelength for transmissions from the antenna where the antenna works best. LAMBDA along with L, W, and H may be selected so as to satisfy the equation:

L+W+H−G=LAMBDA/(4*sqrt(EPSILON_R))

The distance between the feed 120 and the ground 122 may be adjusted. The thickness of the ground lead 122 may be selected by studying the impedance and resonant frequency of the antenna and the impedance of the circuitry that drives the antenna (the RF Front End).

The position, size and geometry of the ground lead depends on the impedance required of the antenna (to match it to the RF front end). In one aspect, it can be placed close to edge of the speaker pot to maximize the usable length of the speaker used as an antenna. It can be adjusted by studying the impedance and tuning it to the amount required to match it to the RF front end.

Simultaneous operation of the speaker as a speaker (providing sounds to a listener and as an antenna (where RF signals are transmitted) is provided. As described elsewhere herein, inductors may be provided in the printed circuit board 118 and these may be connected between the audio leads 116 of the speaker and other electronics in the printed circuit board 118. The purpose of the inductors is to prevent RF currents from moving from the speaker to the PCB. In other words, these currents are prevented from moving across the inductors (at high frequencies, the inductors present a high impedance). The inductors may also be placed inside the speaker or on/inside the speaker box.

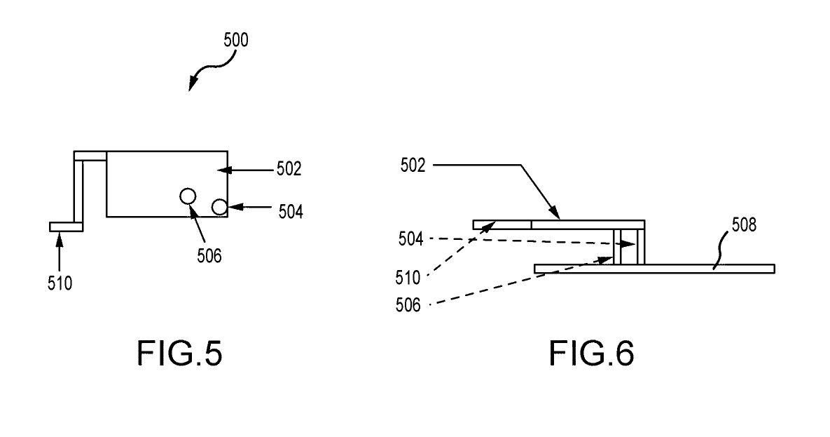

Referring now to FIG. 5 and FIG. 6, one example of a speaker or receiver 500 used an antenna with an antenna extension is described. The speaker 500 shown in these figures is similar to the one shown in FIGS. 1-4, except that an extension is used. The receiver 500 includes a pot 502, an antenna ground 504, an antenna feed 506, a printed circuit board (PCB) 508, and an antenna extension 510.

As mentioned, the speaker 500 may be as that described above with respect to FIGS. 1-4, and that description will not be repeated here.

The antenna extension 510 in one example is a metal trace that elongates the antenna. Examples of metal that can be used include Copper, bronze, stainless steel, LDS traces. The extension can be used when the speaker pot size is too small or too inefficiency from a radiation point of view for the pot to be an antenna by itself. It will be appreciated that the antenna extension can be selected according to the frequency of the desired transmissions for the antenna. The extension 510 can be attached to the pot 502 by any suitable approach such as welding. The extension 510 can be a wire, or a thicker elongated piece of metal that is shaped according to any configuration (e.g., straight or bent). The extension may also take the form of an LDS trace or a trace on a flexible or non-flexible PCB.

As with the examples described elsewhere herein, simultaneous operation of the speaker as a speaker (providing sounds to a listener and as an antenna (where RF signals are transmitted) is provided. As described elsewhere herein, inductors may be provided in the printed circuit board 508 and these may be connected between the audio leads of the speaker and other electronics in the printed circuit board 508. The purpose of the inductors is to prevent RF currents from moving from the speaker to the PCB. In other words, these currents are prevented from moving across the inductors (at high frequencies, the inductors appear as an open circuit).

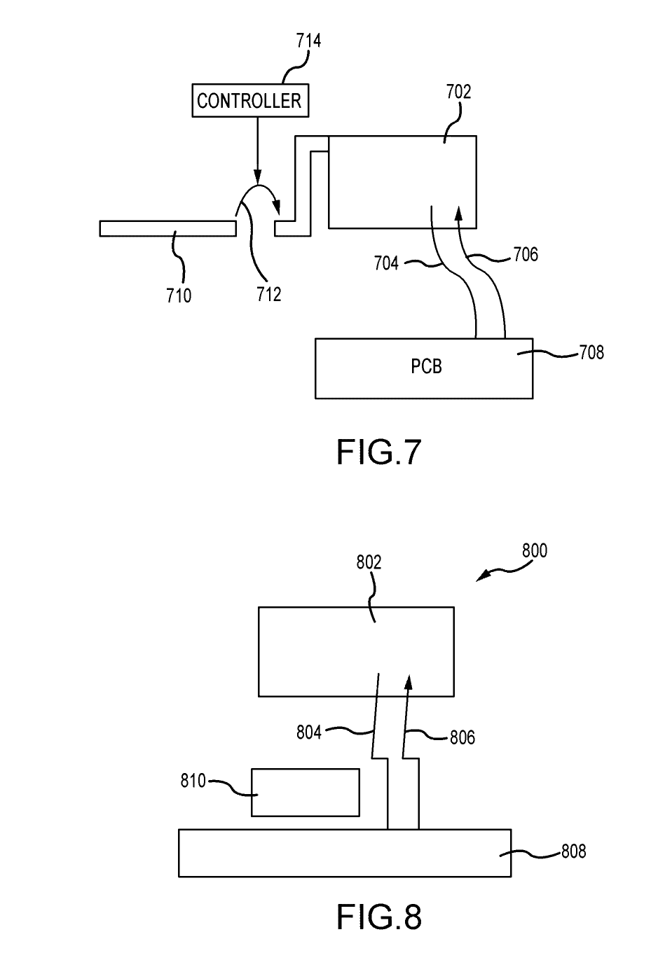

Referring now to FIG. 7, one example of a receiver 700 with an extended antenna is described. The receiver 700 includes a pot 702, an antenna ground 706, an antenna feed 704, a printed circuit board (PCB) 708, and an antenna extension 710. A switch 712 activated by a controller 714 selectively couples and de-couples the antenna extension 710. The antenna extension 710 can be added or omitted from the overall antenna formed with the pot 702 to allow the varying of the transmission frequency of the antenna.

Referring now to FIG. 8, another example of a speaker 800 used as an antenna is described. A speaker 800 includes a pot 802, an antenna ground 806, and antenna driver 804. The speaker 800 is disposed above a printed circuit board 808. A dielectric material 810 (e.g., a piece of plastic underneath between PCB 808 and pot 802.

The speaker 800 may be as that described above with respect to FIGS. 1-4, and that description will not be repeated here.

The dielectric material 810 may be plastic but other examples of other materials (such as ceramics) may also be used. This deployment is effective to alter the frequencies at which the receiver antenna can radiate. The shape, thickness, and other dimensions of the dielectric material 810 may be altered according to the desired frequency needed.

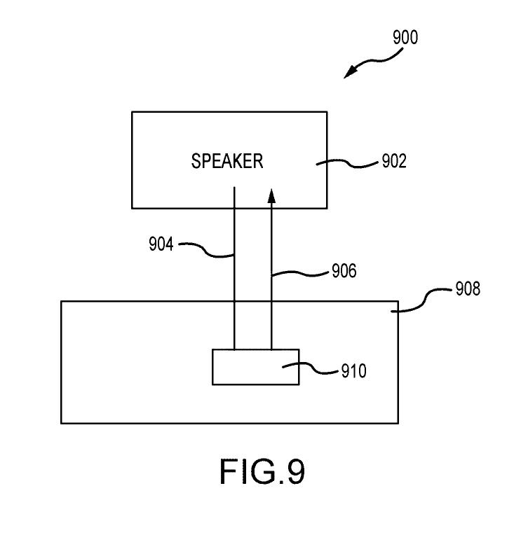

Referring now to FIG. 9, one example of electrical circuits in the PCB is described. A speaker 900 includes a pot 902, an antenna ground 902, and antenna driver 906. The speaker 900 is disposed above a printed circuit board (PCB) 908.

The PCB 908 includes electrical circuit or circuits 910. The electrical circuit or circuits 910 may include various combinations of fixed or variable inductors, capacitors, resistors, or other impedance matching components to mention a few examples. Other examples are possible. A switch may also be used to select from different impedance matching circuits or make the antenna resonate at different frequencies. The various components can be used to provide various functions such as matching the impedance of the antenna with that of the RF circuitry. Other examples of functions are possible.

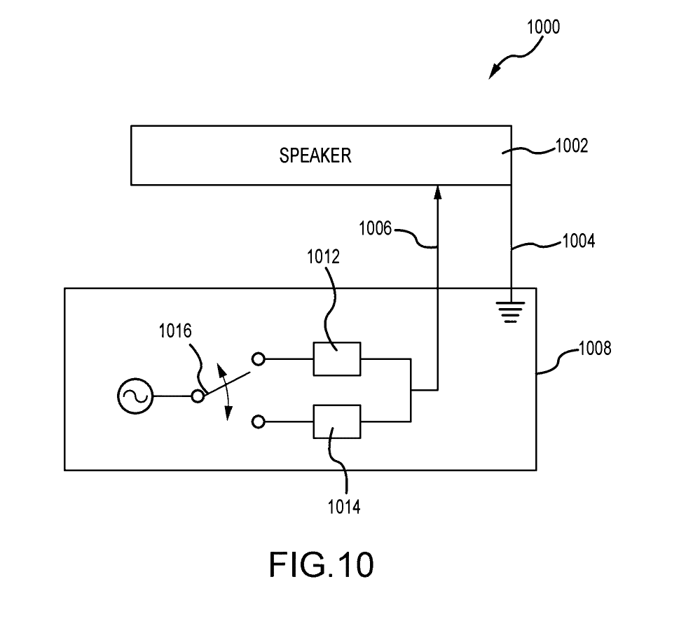

Referring now to FIG. 10, one example of electrical circuits and a switch on PCB is described. A speaker 1000 includes a pot 1002, an antenna ground 1002, and antenna driver 1006. The speaker 1000 is disposed above a printed circuit board (PCB) 1008.

The PCB 1008 includes electrical circuits 1010 and 1012, which in one example are impedance matching circuits with differing values. The function of the impedance matching circuits 1010 and 1012 is to match the impedance of the antenna with the impedance of the RF circuitry. A switch 1014 (controlled by a controller) selectively switches in one of the circuits 1010 or 1012 depending upon the amount of matching that is desired. The circuits 1010 and 1012 may also be other types of electrical circuits that include inductors, capacitors, resistors, and combinations of these elements mention a few examples. Other examples are possible.

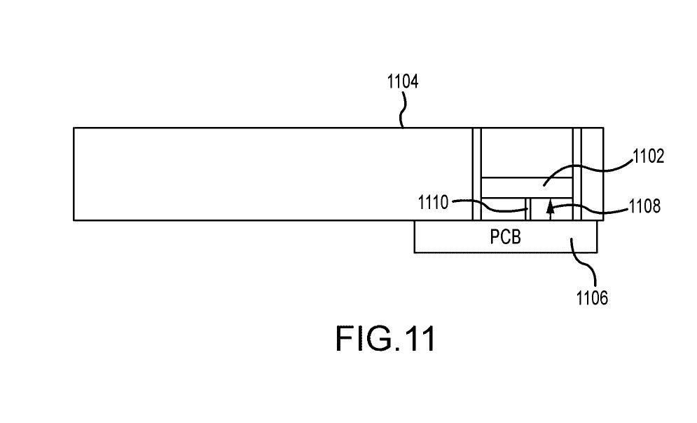

Referring now to FIG. 11, one example of integrated speaker assembly with antenna leads is described. A speaker 1102 is placed in an integrated assembly 1104. The integrated assembly 1104 may be used to position the speaker 1102 with respect to a printed circuit board (PCB) 1106. Antenna drive 1108 and ground 1110 extend from the PCB 1106 to the speaker 1102.

The integrated assembly 1104 may be used to hold other components such as antenna extensions. The receiver may be an integrated speaker assembly (or box) or an integrated receiver assembly (or box) where many of the above techniques can be implemented. By integrated speaker assembly (or box), it is meant a speaker that is substantially integrated into an assembly or housing. By integrated receiver assembly (or box), it is meant a receiver that is substantially integrated into an assembly or housing. The integrated assembly 1104 may be constructed in one example of plastic. Other examples of materials or combinations of materials may also be used.

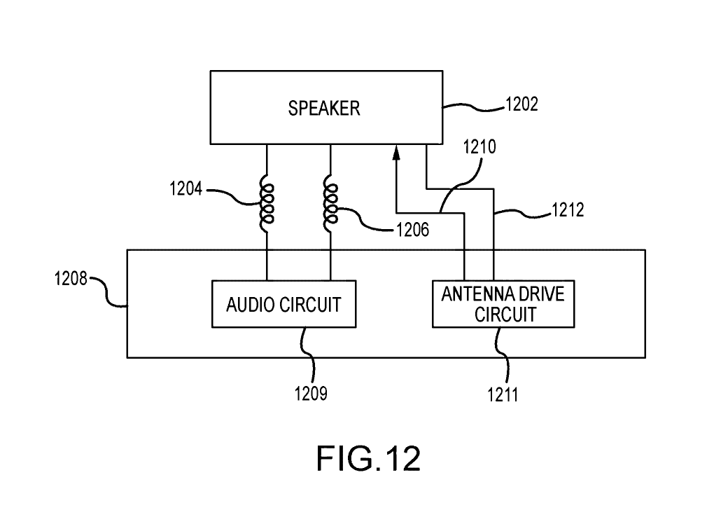

Referring now to FIG. 12, one example of operating the speaker as both an audio speaker and an antenna is described. A speaker 1202 may be the speaker described above with respect to any of the figures. Inductors 1204 and 1206 connect the speaker 1202's audio circuit to a printed circuit board (PCB) 1208 that includes an audio circuit 1209 and an antenna drive circuit 1211. An antenna ground 1212 and antenna drive lead 1210 couple to the pot of the speaker as has been described.

At low frequencies, the audio circuit drives the speaker 1202 (including the coil and the magnet in the speaker) to produce sound that is presented to the listener. At high frequencies, the inductors 1204 and 1206 provide a high impedance effectively de-coupling the speaker from the PCB, and then the speaker 1202 can be used as an antenna as has been described.

The inductors 1204 and 1206 are choking components are placed between the speaker's audio ports and device's circuitry 1209 to block higher frequency RF currents from flowing across them. These choking components may also be included in the receiver/speaker assembly or in a speaker box as well. Other choking components that can be used include common mode chokes, ferrite beads, and capacitors to mention a few examples. Other examples are possible.

Preferred embodiments of this invention are described herein, including the best mode known to the inventors for carrying out the invention. It should be understood that the illustrated embodiments are exemplary only, and should not be taken as limiting the scope of the invention.

1. A combination speaker and antenna device, the combination speaker and antenna device comprising:
a printed circuit board (PCB);
a speaker apparatus disposed on the PCB, the speaker apparatus comprising:
a basket;
a magnet system located in the basket and configured to create a magnetic field, the magnet system comprising:
a pot;
at least one magnet situated within the pot; and
a top plate located on the magnet on a surface opposite the pot;
a membrane attached to the basket; and
a voice coil attached to the membrane and disposed within the magnetic field created by the magnet system; and
an antenna circuit comprised of an antenna feed and an antenna ground, both connected between the PCB and the speaker apparatus,
wherein the antenna circuit provides an RF signal to the speaker apparatus and one or more parts of the speaker apparatus acts as an antenna.

2. A combination speaker and antenna device according to claim 1, wherein the pot is comprised of a metal and the antenna feed and antenna ground are connected to the pot.

3. A combination speaker and antenna device according to claim 2, further comprising an elongate antenna extension attached to the pot, the antenna extension comprised of a metal and configured to increase the area acting as an antenna.

4. A combination speaker and antenna device according to claim 3, further comprising a controller and a switch, wherein the elongate antenna extension is attached to the pot via the switch and the switch is configured to selectively couple and decouple the antenna extension from the pot, wherein the controller is electrically coupled to the switch and configured to activate the switch.

5. A combination speaker and antenna device according to claim 1 further comprising a dielectric material located between the speaker apparatus and the PCB.

6. A combination speaker and antenna device according to claim 1 further comprising audio leads connected between the PCB and the voice coil, the audio leads supplying an audio signal to the voice coil.

7. A combination speaker and antenna device according to claim 6 further comprising one or more inductors connected between the audio leads and the PCB and configured to prevent RF currents from traveling from the speaker apparatus to the PCB through the audio leads.
